(19) United States
(12) Patent Application Publication
(10) Pub. No.: US 2026/0184348 A1
(43) Pub. Date: Jul. 2, 2026

(54) GENERATING SYNTHETIC DRIVING SCENES USING DIFFUSION MODELS

(71) Applicant: Zoox, Inc., Foster City, CA (US)

(72) Inventors: Ethan Miller Pronovost, Redwood City, CA (US); Meghana Reddy Ganesina, Redwood City, CA (US); Nicholas George Dilip Roy, Needham, MA (US)

(21) Appl. No.: 18/222,158

(22) Filed: Jul. 14, 2023

(51) Int. Cl. B60W 60/00; B60W 40/02; B60W 50/00

(52) U.S. Cl. CPC B60W 60/0027; B60W 40/02; B60W 2050/0028; B60W 2554/402; B60W 2554/4041; B60W 2554/4046

(57) ABSTRACT

Techniques are described herein for generating synthetic driving scenes using diffusion models. In various examples, a driving scene generator may provide the diffusion model with map data representing a driving environment, and any number of agent tokens representing predetermined agents in the driving environment. The diffusion model may be trained to populate the driving environment with additional agents, including generating and positioning the additional agents in a realistic manner relative to the predetermined agents, to generate a synthetic driving scene. Synthetic driving scenes generated with diffusion models may be used to execute realistic simulations targeting specific driving scenarios.

### BACKGROUND

Simulated data and simulations can be used to test and validate the features and functionalities of systems, including features and functionalities that may be otherwise prohibitive to test in the real world (e.g., due to safety concerns, limitations on time, repeatability, etc.). For example, autonomous vehicles and other robotic devices may use driving simulations to test and improve passenger safety, vehicle decision-making, sensor data analysis, and route optimization. Driving simulations may be executed by controlling simulated vehicles and/or other agents within simulated driving environments. Simulated driving environments can include driving scenes captured within the log data of vehicles traversing real-world driving environments, and/or may include synthetically generated driving scenes. Synthetic driving scenes may provide a number of advantages for performing driving simulations, including the ability to test specific driving scenarios for which log data might not be available. However, creating synthetic driving scenes for simulations that both accurately reflect real-world driving scenarios and validate functionality of vehicle systems is technically challenging. For example, manual generation of realistic synthetic scenarios by users can be time-consuming, while programmatically generated synthetic scenarios often fail to reflect real-world agent behaviors and interactions.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example technique using a driving scene generator to generate a synthetic driving scene using a diffusion model and agent tokens, in accordance with one or more examples of the disclosure.

FIG. 2 is an example block diagram including a diffusion model and a variable autoencoder configured to generate synthetic driving scenes, in accordance with one or more examples of the disclosure.

FIG. 3 is another example block diagram illustrating training and inference operations including a diffusion model and a variable autoencoder, in accordance with one or more examples of the disclosure.

FIG. 4 illustrates an example technique for training a diffusion model to generate synthetic driving scenes, in accordance with one or more examples of the disclosure.

FIG. 5 illustrates an example technique of using a diffusion model to generate multiple synthetic driving scenes based on random noise samples, in accordance with one or more examples of the disclosure.

FIG. 6 illustrates an example technique of using a diffusion model to generate synthetic driving scenes having different scene densities, in accordance with one or more examples of the disclosure.

FIG. 7 depicts a block diagram of an example system for implementing various techniques described herein.

FIG. 8 is a flow diagram illustrating an example process for generating synthetic driving scenes and executing driving simulations based on the synthetic driving scenes, in accordance with one or more examples of the disclosure.

### DETAILED DESCRIPTION

This application describes techniques using diffusion models to generate synthetic driving scenes and/or scenarios. In various examples described herein, a driving scene generator may receive map data representing a driving environment, and object data relating to one or more predetermined objects (e.g., agents) to be placed in the driving environment. The driving scene generator may generate agent tokens representing the predetermined agents, and may provide the map data and agent tokens to a diffusion model. The diffusion model may be trained to generate a synthetic driving scene based on the map data and agent tokens, including populating the driving scene with the predetermined agents and additional agents that are generated and positioned realistically relative to the predetermined agents. Synthetic driving scenes generated based on trained diffusion models using the techniques described herein may be used to execute realistic driving simulations targeting specific driving scenarios.

A driving scene (which also may be referred to as a scenario) may refer to a real or virtual driving environment in which a vehicle may operate over a period of time. Within driving simulation systems, driving scenes may be represented as virtual environments in which the vehicle control systems and/or other software-based systems and features of autonomous vehicles can be tested and validated. Within real-world environments, driving scenes can be represented by static objects and/or agents (e.g., dynamic objects) in the physical environment proximate to a vehicle. For driving scenes represented in real or virtual environments, the driving scenes may include map data and/or environment data representing a road configuration around the vehicle, and also may include road conditions, weather conditions, lighting conditions, etc. Driving scenes also may include data representing the vehicle that may be validated in the simulation, and data representing any number of additional agents and/or other objects in the environment. For instance, data representing a driving scene may include object types, positions, sizes, headings, velocities, and/or other state data, for the vehicle itself and for any number of additional agents proximate to the vehicle in the environment. In some examples, driving scene data may include a representation of the environment over a period of time, rather than a single snapshot of the environment, so that the vehicle systems may receive the driving scene as input data, detect changes in the environment over time, and perform driving maneuvers and/or behaviors based on a predicted future state of the environment.

As noted above, techniques described herein relate to using diffusion models to generate synthetic driving scenes that can be used to perform driving simulations (and/or can be used to control a vehicle in a physical environment). In some examples, a driving scene generator can implement and train a diffusion model to generate a driving scene, based on input data including map data representing a driving environment and one or more agent tokens representing predetermined agents to be included in the driving scene. The diffusion model may be trained to populate the synthetic driving scene with a number of additional agents, including generating and positioning the additional agents in a realistic manner relative to the predetermined agents represented by the agent tokens. To generate the synthetic driving scene, the diffusion model may receive a random noise sample and may iteratively de-noise the sample, using the map data and agent tokens as conditioning inputs during the iterative diffusion inference operations, to determine a fully formed (e.g., de-noised) realistic synthetic driving scene. In some cases, the diffusion model may be trained to output feature vectors representing the predetermined agents and any additional agents generated during the diffusion inference. The feature vectors output by the diffusion model can be provided to a trained decoder of a variable autoencoder, which may be configured to receive the map data representing the driving environment and the feature vectors from the diffusion model, and to output agent representations (e.g., bounding boxes, sizes, locations, headings, types, etc.) for the agents in the driving scene.

In some examples, agent tokens may have a one-to-one relationship with agents, so that each agent token provided to the diffusion model may represent a single predetermined agent that is to be included in the synthetic driving scene. The agent tokens provided to the diffusion model may be generated as feature vectors, using a domain-specific language that may describe any number of characteristics of an agent in a driving environment. For instance, an agent token can include encoded data representing the size dimensions (e.g., length, width, and/or height), location (e.g., in pixels relative to the map data), and heading (or orientation) of a single predetermined agent. Additionally or alternatively, agent tokens representing predetermined agents may include agent type data (e.g., vehicle, bicycle, pedestrian, animal, etc.), subtype data (e.g., compact car, bus, emergency vehicle, etc.). Additionally or alternatively, agent tokens also may include various encoded motion data for a predetermined agent, such as agent speed, velocity, trajectory data, and/or a driving maneuver or behavior to be performed by the agent within the synthetic driving scene.

As shown in these examples, an agent token may include data describing one or more attributes of an agent that is to be generated by the diffusion model in a synthetic driving scene. In various examples, agent token need not include all of the attributes of the corresponding agent that will be generated by the diffusion model. For instance, an agent token may include bounding box data (e.g., x-and y-position data, size data, heading data, etc.) but might not include trajectory data. In this instance, the diffusion model may generate a corresponding agent during de-noising that comports with the bounding box data of the agent token and also includes a realistic trajectory generated determined by the diffusion model. As another example, an agent token may include location information only, and the diffusion model may generate a bounding box and trajectory for the corresponding agent. In other cases, agent tokens may include trajectory data (with or without bounding box data), and the diffusion model may generate corresponding agents based on the trajectory data. Thus, an agent token can specify any subset of the various agent attributes described herein, and the diffusion model may use the agent tokens to generate corresponding agents that include the specified subset of agent attributes and while also determining the additional unspecified agent attributes during de-noising. Agent tokens may therefore provide a layer of abstraction to allow the designers of synthetic driving scenes to provide any subset of agent attribute data to predetermine driving scenes with one or more agents, and the diffusion model may generate complete and realistic synthetic driving scenes based on the specified subset of agent attribute data.

In some examples, multiple agent tokens may be provided to the diffusion model, where each different agent token includes the same set of agent attributes (e.g., agent position, agent size, agent heading, etc.) for a different predetermined agent to be generated by the model. In other examples, the diffusion model may be configured to receive different agent tokens representing different subsets of agent attributes. For instance, a first agent token provided to the model may describe an agent position, size, and trajectory for a first agent to be generated in the synthetic driving scene, while a second agent token may describe only a position for a second agent to be generated (e.g., and need not include a size or a trajectory). In these examples, the diffusion model may determine (via the de-noising process) a realistic trajectory for the second agent, based on the specified position, size, and trajectory of the first agent, and based on the specified position of the second agent. Further, as described herein, the diffusion model also may be configured to generate any number of additional agents within the synthetic driving scene, which may include determining the positions, sizes, headings, object types, trajectories, and/or other attributes for each of the additional agents, based on the agent attributes specified in the collection of agent tokens provided to the model.

As noted above, agent tokens may have a one-to-one relationship with agents, so that each agent token corresponds to a single agent to be generated by the diffusion model for the synthetic driving scene. In other examples, agent tokens may have a many-to-one relationship with agents, so that multiple agent tokens can correspond to the same agent within a synthetic driving scene. In such examples, different types of agent tokens may be used to represent different subsets of agent attributes. As an example, a first agent token of a first type may specify the position and size of a first agent, and a second agent token of a second type may specify the trajectory of the first agent. In this example, a third agent token of the first type may specify the size and position of a second agent (but there may be no agent token to specify a trajectory for the second agent). Similarly, a fourth agent token of the second type may specify the trajectory of a third agent (without an agent token specify the size and position of the third agent). As these examples illustrate, an architecture using many-to-one relationships between agent tokens and agents may provide additional flexibility for designers of synthetic driving scenes to create predetermined agents having different subsets of specified agent attributes.

The driving scene generator may receive data representing one or more predetermined agents to be included in the driving scene from a user or other client computing system. For instance, a user generating driving scenes for performing a simulation battery may provide data to the driving scene generator (e.g., via a user interface) an indication a desired configuration of one or more predetermined agents to be included in the driving scenes. The configuration of predetermined agents may include the vehicle to be validated in the simulation (positioned at a particular location in the map data), and one or more other agents positioned relative to the vehicle (e.g., a car following the vehicle, a truck in the lane to the left of the vehicle, a bicycle in the crosswalk in front of the vehicle, etc.). As described below in more detail, the driving scene generator may receive the predetermined agent data from the user or client system, and may generate agent tokens representing the desired configuration of predetermined agents to be included in the driving scene. The driving scene generator then may use a cross-attention mechanism to provide the agent tokens as conditioning inputs to the diffusion model.

As an example, the driving scene generator may receive predetermined agent data indicating a first position and state of the vehicle to be validated in the simulation (e.g., in the left lane approaching a crosswalk), and a second position and state of another predetermined agent (e.g., a truck stopped in the right lane at the crosswalk). As another example, the driving scene generator may receive predetermined agent data indicating a first position and state of the vehicle to be validated in the simulation (e.g., in the center lane of a three-lane highway), a second position and state of a second predetermined agent (e.g., a car tailgating the vehicle in the same lane), and a third position and state of a third predetermined agent (e.g., a bus merging from the left lane in front of the vehicle). In these examples, based on the map data and the agent tokens (e.g., two agent tokens in the first example and three agent tokens in the second example), the diffusion model may be configured to determine any number of additional agents for the driving scene. In particular, the diffusion model may be trained using realistic ground truth driving scenes, so that it can determine the additional agents for the synthetic driving scene such that the types, sizes, positions, and orientations of the additional agents are realistic relative to the particular driving environment, the predetermined agents. and the other additional agents.

As noted above, the diffusion model is configured to generate a synthetic driving scene from an initial random noise sample. The diffusion model may be trained based on latent embeddings of the variable autoencoder, using a training process in which the latent embeddings are “diffused” by adding noise (e.g., masking out a subset of the agents in the driving scene), and then subsequently de-noising by the diffusion model (e.g., adding agents back into the driving scene). After the diffusion model has been trained, it can be used to generate synthetic driving scenes based on random noise samples, by iteratively de-noising each sample while using the map data and agent tokens as conditioning inputs during the de-noising operations. The execution of the diffusion model (e.g., diffusion inference) may generate a latent embedding representing a driving scene, based on a random noise sample, which may be decoded by the decoder of the variable autoencoder, into a new synthetic driving scene. Additional examples of techniques for generating representations of objects in driving environments can be found, for example, in U.S. patent application Ser. No. 18/087,570, filed Dec. 22, 2022, and titled “Generating Object Representations Using a Variable Encoder,” and in U.S. patent application Ser. No. 18/087,540, filed Dec. 22, 2022, and titled “Latent Variable Determination By A Diffusion Model,” both of which are incorporated by reference herein, in their entirety, for all purposes. Although various examples herein describe using diffusion models to generate synthetic driving scenes, other types of models can be used in such examples. For instance, any generative model that supports text-based conditioning may be used to generate synthetic driving scenes with conditioning by agent tokens, in any or all of the examples described herein.

Because the diffusion model (along with the variable autoencoder) is trained to generate synthetic driving scenes from initial random noise samples, it can generate any number of realistic driving scenes based on the same map data and the same agent tokens. For instance, after receiving the map data and determining the agent tokens for the predetermined agents to be included in the scene, the diffusion model can be executed on a first random noise sample to generate a first synthetic driving scene, then executed again on a second random noise sample to generate a second synthetic driving scene, and so on. Within the diffusion inference operations, the latent embeddings for each synthetic driving scene may develop independently as its random noise sample is iteratively de-noised, so that each of the resulting driving scenes is unique and independent, while also representing a realistic real-world driving scene based on the training of the diffusion model with real-world ground truth driving scenes.

In some examples, a diffusion model used to generate synthetic driving scenes also may support different levels of scene density. For instance, the driving scene generator may provide another token to the diffusion model, in addition to the agent tokens representing the predetermined agents, to indicate a desired scene density and/or a number of additional agents to be generated by the diffusion model. The additional token, which may be referred to as a scene density token, can indicate the number of additional agents that the diffusion model should generate for the driving scene during the de-noising operations. In various examples, the scene density token can identify the number of agents to be generated by the diffusion model, and/or a scene density metric (e.g., a dropout percentage) indicating what percentage the agent tokens represent of the overall number of desired agents in the driving scene. As an example, if the driving scene generator provides the diffusion model with two agent tokens and a scene density token indicating a 50% dropout percentage, the diffusion model will de-noise the random noise sample into a synthetic driving scene having approximately 4 total agents. As another example, if the driving scene generator provides the diffusion model with two agent tokens and a scene density token indicating a 90% dropout percentage, the diffusion model will de-noise the random noise sample into a synthetic driving scene having approximately 20 total agents.

As illustrated by these examples, scene density tokens and agent tokens are different types of tokens that represent and encode different types of conditioning data to be used by the diffusion model when de-noising a noise sample into a driving scene. As a result, the driving scene generator may use different embeddings for scene density tokens and agent tokens (e.g., different multilayer perceptrons (MLPs), transformers, etc.), but may feed both types of tokens through the same cross-attention layer to provide the tokens to the diffusion model.

In some examples, the diffusion model may be configured to generate additional agents having fixed sets of characteristics that match the characteristics of the predetermined agents. For instance, when the agent tokens provided to the diffusion model include the agent size (e.g., length and width), position, and heading, then each of the additional agents generated by the diffusion model may include the same characteristics (e.g., agent size, position, and heading). In such examples, a diffusion model is configured to receive agent tokens having additional characteristics (e.g., agent type, velocity, trajectory, etc.), then the additional agents generated by the diffusion model also may have the same additional characteristics. However, in other examples, the diffusion model can be configured in a more flexible manner, in which the agent tokens provided to the model include fewer agent characteristics (e.g., agent location and/or heading only), and the model is configured to output additional agent characteristics (e.g., agent location, type, size, and heading, etc.) both for the predetermined agents and the additional agents.

Additionally, in some cases, the driving scene generator may use different diffusion models trained to receive agent tokens having different levels of granularity. For instance, a first diffusion model may be trained to receive agent tokens that identify precise specific locations and sizes for the predetermined agents (e.g., features vectors that encode the precise pixel-level agent boundaries within the map data), while a second diffusion model may be trained to receive agent tokens that identify locations and sizes for the predetermined agents more broadly (e.g., using a size/location threshold, using generalized locations (e.g., right, left, front, or back) relative to the vehicle to be validated in the simulation,. etc.). Similar differences in granularity may be used for other attributes (e.g., heading, agent speed or velocity, trajectory, etc.) in different diffusion models. In these examples, agent tokens having courser levels of granularity may provide advantages of allowing the user (and/or client system) to broadly define a relevant driving scene configuration for simulation testing (e.g., an agent in front of the vehicle performing a left-to-right lane change), and then relying on the diffusion model to determine any number of realistic synthetic driving scenes that satisfy the broadly defined agent configuration. In contrast, agent tokens having finer levels of granularity may provide additional advantages of allowing the user (and/or client system) to define specific and precise agent configurations for more targeted simulation testing (e.g., an agent exactly 18 inches in front of the vehicle driving at exactly 24 MPH, etc.), and then relying on the diffusion model to determine the remainder of the synthetic driving scene in a realistic manner.

As noted above, a diffusion model may be trained based on latent embeddings generated by a variable autoencoder. The variable autoencoder may use an encoder-decoder architecture (e.g., within a Convolutional Neural Network (CNN), Generative Adversarial Network (GAN), a GNN, a Recurrent Neural Network (RNN), another transformer model, etc.). The variable autoencoder may be trained to downsample driving scenes (using the encoder) into latent embeddings, and then upsample the latent embeddings back into driving scenes. In some examples, the input to the variable autoencoder may include image data representing a top-down view of a driving scene (e.g., using color to represent agent heading), and the decoder may be configured to output bounding box detections (e.g., rather than image data). In other examples, the variable autoencoder may be configured to receive any other type of driving scene representation for the encoder input and/or to generate any other type of driving scene representation as the decoder output, including but not limited to top-down image/sensor data, vehicle perspective image/sensor data, top-down multi-channel representations, bounding box (or bounding contour) representations, etc.

When training the diffusion model to generate a synthetic driving scene, a model training component may receive a latent embedding representing a ground truth driving scene encoded by the variable autoencoder. The training process for a diffusion model generally may include “diffusing” the latent embedding by adding noise, and then using the diffusion model to de-noise the latent embedding. In this example, the latent embedding may represent a ground truth driving scene, including a specific driving environment (e.g., map data) populated with any number of independent agents (e.g., vehicles, bicycles, pedestrians, animals, etc.). The training component may initially determine a drop-out percentage for the ground truth driving scene, for example, by sampling to determine a dropout probability (e.g., from 0% to 100% agent dropout). The training component then may determine a dropout mask based on the determined dropout probability, and using the mask to mask out a subset of agents in the driving scene. The latent embedding of the masked driving scene then may be provided to the diffusion model to “de-noise” the driving scene by adding agents back into the driving scene. Using these techniques, the diffusion model may be trained to generate realistic driving scenes from masked-out latent embeddings, including determining realistic relative positions of agents, realistic agent characteristics, and realistic potential interactions between agents within the driving scene. The diffusion model training techniques described herein may allow the model to learn the meaning of the positioning of particular agents, including how agent positioning relates to other agents in the driving scene and objects in the driving environment (e.g., curbs, sidewalks, crosswalks, traffic signals, etc.). As a result, when a trained diffusion model is provided with a number of agent tokens during inference, the diffusion model will have learned to populate the driving scene with additional agents that realistically take into account the structure of complex driving scenes including relationships and interactions between agents.

After the diffusion model has generated a synthetic driving scene (e.g., as a de-noised latent embedding), the driving scene generator may decode the latent embedding (e.g., using the decoder of the variable autoencoder) into a driving scene that can be used by various downstream components. Various examples described herein include using synthetic driving scenes generated by the diffusion model to perform driving simulations. In such examples, generating driving scenes using diffusion models (and/or variable autoencoders) may provide a number of technical advantages when testing and validating the vehicle control systems of autonomous vehicles. For instance, using diffusion models to generate synthetic driving scenes, including providing map data and agent tokens representing a predetermined configuration of agents to the diffusion model, may allow for more robust coverage of simulated driving scenes and simulation scenarios that do not occur frequently in real-world driving situations. For these low-frequency driving scenes/scenarios, relatively less training data (e.g., vehicle log data) may be available, and therefore, driving scene generation models relying solely on ground truth driving scenes may fail to adequately test vehicle systems when encountering uncommon scenarios. In contrast, the use of agent tokens within diffusion models as described herein allows the driving scene generator to efficiently generate realistic driving scenes, allowing users to specify particular subsets of predetermined agent configurations, but without requiring users to perform time-consuming manual scene generation.

Although various examples describe using the synthetic driving scenes generated by the diffusion model to perform driving simulations, in other examples, the techniques described herein may include generating synthetic driving scenes for use by various other components, including on-vehicle components used to control an autonomous vehicle within a real-world driving environment. For example, a prediction component of an autonomous vehicle may perform driving scene predictions based on the output of the diffusion model (e.g., for partially occluded portions of a driving environment), and such predictions may be considered during vehicle planning operations for the autonomous vehicle, to improve vehicle safety by planning for the possibility that additional agents in the driving environment may potentially intersect with or otherwise affect the autonomous vehicle in the environment. The techniques described herein may be used for generating synthetic driving scenes on which to perform driving simulations, as well as for various other tasks relating to generating synthetic data via trained diffusion (or generative) models. For instance, the techniques described herein can be used to train models to predict occluded objects within an environment (e.g., de-noising occluded regions of an environment based on the attributes of non-occluded objects).

The techniques described herein may be implemented in a number of ways. Example implementations are provided below with reference to the following figures. Although discussed in the context of an autonomous vehicle, the methods, apparatuses, and systems described herein may be applied to a variety of systems (e.g., a sensor system or a robotic platform), and are not limited to autonomous vehicles. In one example, similar techniques may be utilized in driver-controlled vehicles in which such a system may provide an indication of whether it is safe to perform various maneuvers. In various other examples, the techniques may be utilized in an aviation or nautical context, and may be incorporated into any ground-borne, airborne, or waterborne vehicle using route planning techniques, including those ranging from vehicles that need to be manually controlled by a driver at all times, to those that are partially or fully autonomously controlled.

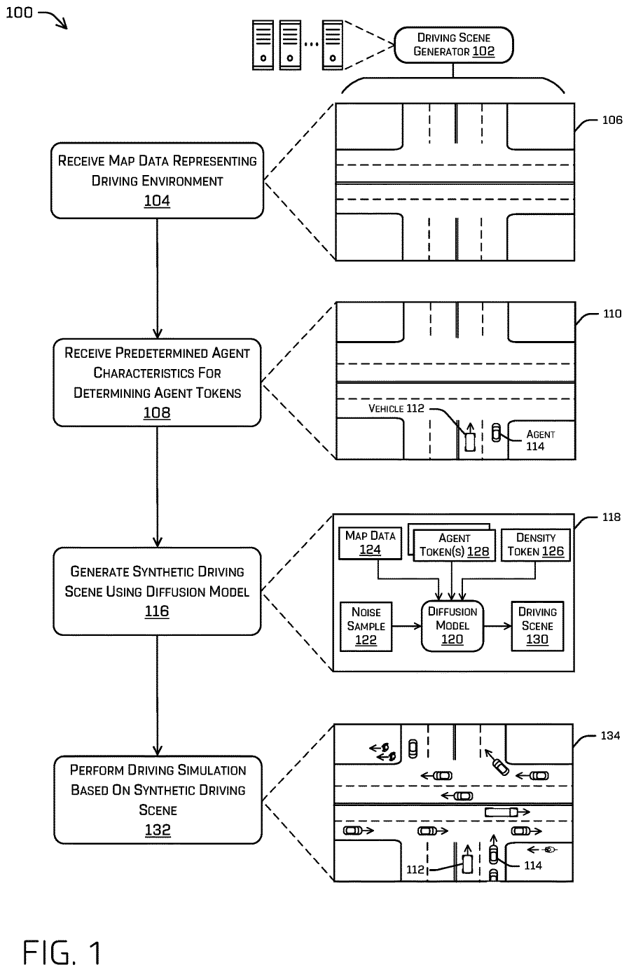

FIG. 1 depicts an example process 100 in which a driving scene generator 102 may use a diffusion model and agent tokens to generate a synthetic driving scene. In some examples, the driving scene generator 102 may be integrated into or associated with a simulation system configured to perform driving simulations based on the synthetic driving scenes generated by the driving scene generator 102.

At operation 104, the driving scene generator 102 may receive map data representing a driving environment for a synthetic driving scene to be generated. In various examples, map data received in operation 104 may include image data, a top-down multi-channel representation, and/or any number of data structures (e.g., modeled in two dimensions, three dimensions, etc.) capable of providing information about a driving environment. The map data may include, but is not limited to, road network topologies including streets and intersections, drivable surface data, sidewalks, driveways, curbs, crosswalks, traffic signs and signals, lane data, road marking, road condition data, etc. In some cases, the map data may correspond to real-world map data captured by sensors of a vehicle, received from a map server, captured from a surveillance camera or satellite image, etc. In other cases, the map data may be synthetically generated and need not correspond to a real-world driving environment. For instance, the driving scene generator 102 may provide a map generation user interface that allows users to input (e.g., draw and/or configure) various configurations of driving environments. In this example, the received map data 106 depicts a four-way intersection in which the east-wide highway has a higher speed and right-of-way over the north-side road.

At operation 108, the driving scene generator 102 may determine one or more agent tokens, based on a received set of characteristics of one or more predetermined agents to be included in the synthetic driving scene. In some examples, the characteristics of the predetermined agents may be received by the driving scene generator 102 from a user (e.g., a simulation generation/execution administrator) via a user interface, API, client application, etc. For instance, the user (or other client system) may provide information indicating the number of predetermined agents, along with the sizes, headings, positions of the agents within the driving environment. Additional (or alternative) agent characteristics may be provided in other examples, such as agent type (and/or subtype), speed, velocity, trajectory, etc.

As noted above, each agent token may include data representing an agent to be generated by the diffusion model in the synthetic driving scene. An agent token can include all of the attributes of the corresponding agent in the synthetic driving scene, or may include any specified subset of agent attributes. When an agent token includes only a subset of agent attributes (e.g., agent position data but not trajectory data, agent position and trajectory data but not size or type data, etc.), then the diffusion model may generate a corresponding agent having the specified agent attributes along with additional unspecified attributes that are realistically determined based on the diffusion/de-noising techniques described herein. Additionally, the predetermined agent characteristics may correspond to a particular driving scene that represents an interesting or important scenario for testing in one or more driving simulations. As shown in this example, box 110 includes the map data 106 along with two predetermined agents (e.g., selected and positioned by a user via a user interface) to be included in the synthetic driving scenario. The first agent, vehicle 112, may represent the vehicle to be validated in the simulation, and the second agent 114 may represent another vehicle positioned just in front and in the lane to the right of the vehicle 112. In this example, the combination of the particular driving environment shown in the map data, and the positions and relative configurations of the vehicle 112 and agent 114, may represent an important and/or underrepresented simulation scenario for testing and validating the systems of an autonomous vehicle. In various examples, the positions and relative configuration of the vehicle 112 and the agent 114 may be defined based on input from the user, which may be received at various different levels of granularity, including any combination of broadly and/or narrowly agent characteristics. Additionally, as shown in this example, the predetermined agent characteristics for certain objects (e.g., vehicle 112) may include an associated trajectory, while the predetermined agent characteristics for other objects (e.g., agent 114) need not include a trajectory.

In some examples, when a synthetic driving scene is generated for use in driving simulations, the vehicle that is to be test and validated in the simulation (e.g., vehicle 112) may be labeled with a separate flag to distinguish it from the other agents/objects in the synthetic driving scene. In some cases, a designer of the synthetic driving scene may indicate that the vehicle 112 is the vehicle to be validated in the simulation, causing the driving scene generator 102 to apply the flag to the corresponding vehicle 112 before outputting the synthetic driving scene to a simulation system. In other cases, the diffusion model may be configured to select one of the agents as the vehicle to be validated in the simulation (e.g., based on random selection, based on the scene configuration and/or layout of the objects in the driving scene, etc.).

After receiving agent characteristics for the one or more predetermined agents to be included in the driving scene, the driving scene generator 102 may generate agent tokens to represent the predetermined agents. In some cases, agent tokens may be generated as feature vectors encoding the agent characteristics into a domain-specific language used to determine the various agent characteristics (e.g., size, location, heading, type, velocity, steering angle, trajectory, etc.). As noted above, agent tokens also may have a one-to-one relationship with the predetermined agents, so that the driving scene generator 102 may generate a different agent token representing each different predetermined agent.

At operation 116, the driving scene generator 102 may generate a synthetic driving scene based on the map data 106 and the agent tokens generated in operation 108. As shown in box 118, a diffusion model 120 may be trained to receive a random noise sample 122 and to perform iterative de-noising operations on the sample to generate a synthetic driving scene 230. The driving scene generator 102 also may provide the diffusion model 120 with map data 124 (e.g., corresponding to the received map data 106) and one or more agent tokens 128 (e.g., corresponding to the agent tokens generated in operation 108), which the diffusion model 120 may use as conditioning data during the de-noising operations. In some examples, the driving scene generator 102 may use an attention mechanism to provide the map data 124 and agent tokens 128 to the diffusion model 120. The attention mechanism may include self-attention layers for determining “attention” relationships between the agent tokens (e.g., cross-attention data between the vehicle 112 and the agent 114).

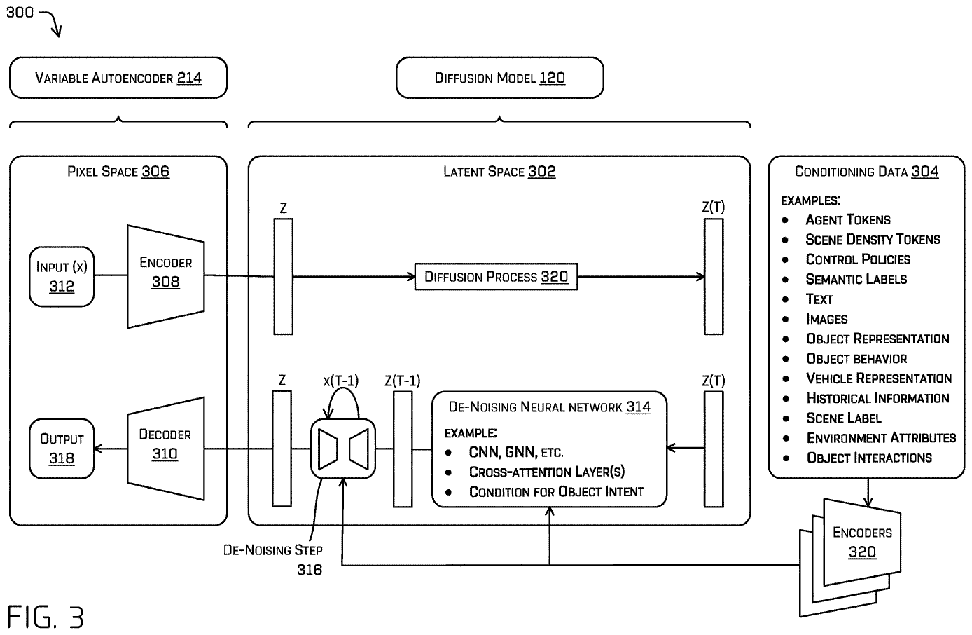

Additionally or alternatively, the driving scene generator 102 may provide additional conditioning data to the diffusion model. For example, the driving scene generator 102 may receive, from a user or other client system via an interface, an indicator of the desired scene density (and/or number of additional agents to generate) for the synthetic driving scene. For instance, a scene density input from a user may include a desired driving scene density, and/or a dropout percentage indicating what percentage the agent tokens 128 represent of the overall number of desired agents in the driving scene. In other examples, the scene density input from the user may indicate a number of total agents and/or a number of additional agents to be generated for the driving scene. Based on the scene density input, the driving scene generator 102 may generate a scene density token 126, which also may be provided to the diffusion model 120 and used as conditioning data during the de-noising operations. Additional examples of conditioning data are described below in reference to FIG. 3.

In this example, box 118 indicates that the diffusion model 120 may directly output the synthetic driving scene 130, by de-noising the random noise sample 122 into a realistic driving scene, using map data 124 and agent tokens 128 as conditioning data during the de-noising. However, as described below in more detail, a more complex architecture may be used in some cases, in which the diffusion model 120 generates and outputs latent variable data associated with the driving scene, rather than the synthetic driving scene itself. In such cases, the latent variable data output by the diffusion model 120 may be decoded by a trained variable autoencoder, which also receives the map data 124, to generate the synthetic driving scene 130.

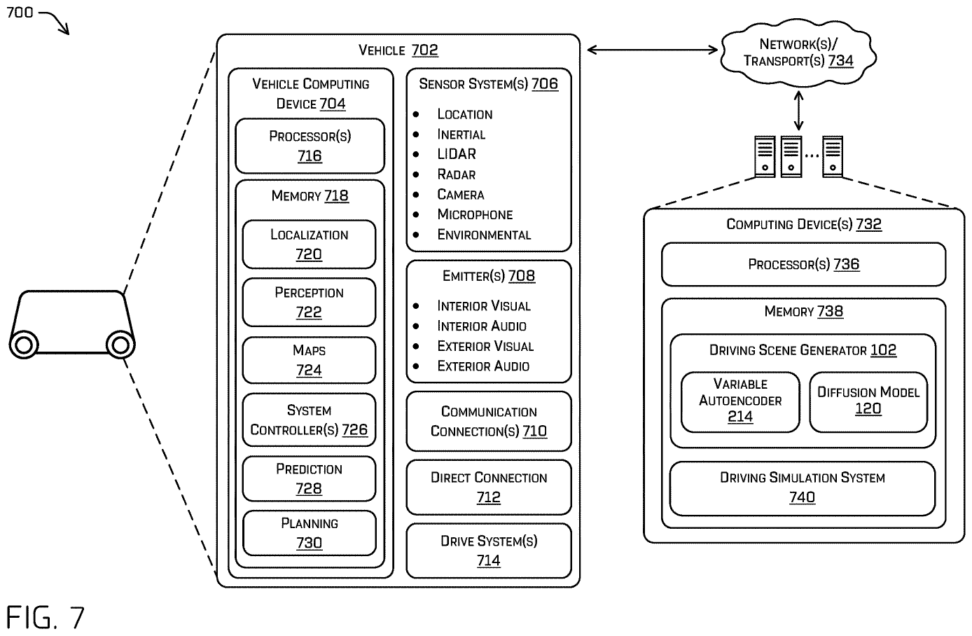

At operation 132, the driving scene generator 102, or a simulation system associated with the driving scene generator 102, may perform one or more driving simulations based on the synthetic driving scene generated in operation 116. For instance, the driving scene generator 102 may provide a representation of the synthetic driving scene to a simulation generation and execution system, such as the driving simulation system 740 described below in reference to FIG. 7. In this example, box 134 includes a depiction of the synthetic driving scene generated using the diffusion model 120. The synthetic driving scene may be represented, for example, as image data and/or as a multi-channel representation of the driving environment, and may include bounding boxes (and/or other shapes, encoded data, etc.) to represent the various agents and/or other objects in the driving scene.

As noted above, the diffusion model 120 (and/or the variable autoencoder) may be trained using real-world driving scene data to generate realistic synthetic driving scenes. For example, the diffusion model 120 may be trained to generate and position additional agents in a realistic manner, based on the conditioning map data 124, agent tokens 128, scene density token 126, etc. The de-noising operations of the diffusion model 120 may generate agent/scene data (e.g., latent variable data) including realistic agent characteristics, realistic positioning of agents relative to other agents and the driving environment, and realistic potential relationships and interactions between the agents/objects of the driving environment. As described herein, the training techniques for the diffusion model may allow the model to learn the meaning of the positioning of particular agents, such as how agent positioning relates to other agents and objects in the driving environment (e.g., curbs, sidewalks, crosswalks, traffic signals, etc.). Thus, the diffusion model 120 may be trained to populate the driving scene, based on the agent tokens 128 and map data 124, with additional agents that realistically model the structure of complex driving scenes, including relationships and interactions between agents.

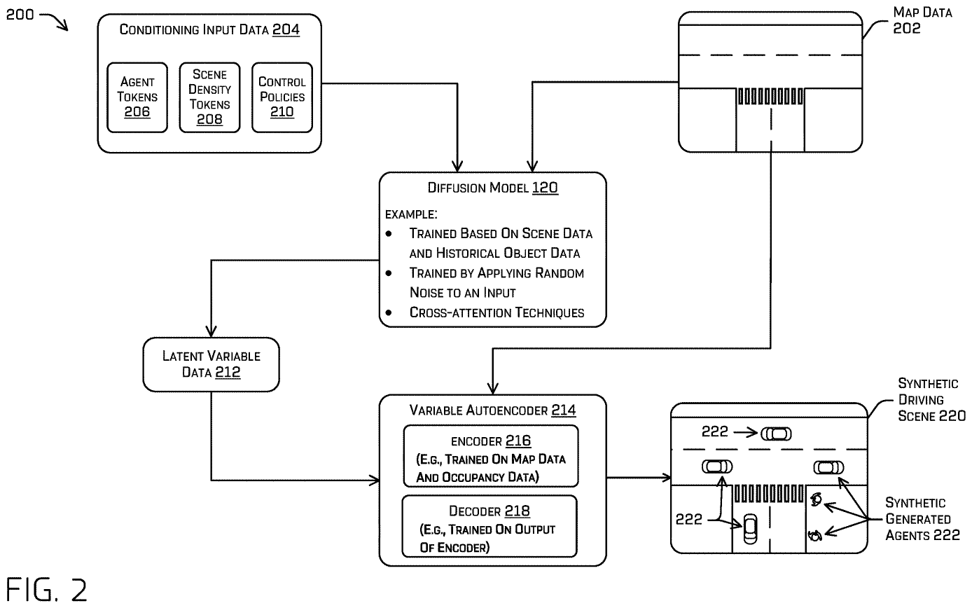

FIG. 2 is a block diagram illustrating an example architecture 200 a computing system that may be used to generate synthetic driving scenes using a diffusion model and agent tokens as described herein. The example architecture 200 may include one or more computing devices (e.g., driving scene generator 102) configured to implement a diffusion model 120 and a variable autoencoder 214. In some examples, the techniques described in relation to FIG. 2 can be performed by a simulation system to generate and perform driving simulations. Additionally or alternatively, the techniques described in relation to FIG. 2 can be performed by an autonomous vehicle while operating in a driving environment (e.g., a real-world environment or a simulated environment).

As described above, the diffusion model 120 may include a trained diffusion model configured to receive map data 202 representing a driving environment (e.g., a real-world or simulated driving environment), and conditioning input data 204 that may guide or control the inference operations of the diffusion model 120 as it de-noises a random noise sample to generate a synthetic driving scene. Using the map data 202 and conditioning input data 204, the diffusion model 120 may generate latent variable data 212 representing a synthetic driving scene. The variable autoencoder 214 may decode the latent variable data 212, and use the decoded the latent variable data and the map data 202 to generate a synthetic driving scene 220 including a number of synthetic generated agents 222.

As noted above, the latent variable data 212 (e.g., a latent embedding) output by the diffusion model 120 may represent the set of agents generated by the model for the synthetic driving scene. In some examples, a latent embedding output by the diffusion model 120 may include feature vectors representing a set of bounding boxes and corresponding trajectories for the set of agents generated by the model for the synthetic driving scene. In other examples, the diffusion model 120 may be configured to output various additional data/attributes for the agents, including (but not limited to) agent speed and/or velocity, agent yaw and/or yaw rate, agent type and/or subtype, and/or other agent characteristics such as driving style (e.g., a driving aggression value, driving safety value, law-abidance value, driver awareness value, etc.).

As shown in this example, the conditioning input data 204 can include agent tokens 206, scene density tokens 208, and/or control policies 210. Agent tokens 206, as discussed above, can include data representing a predetermined agent (e.g., requested by a user or client system) to be included in the synthetic driving scene 220. An agent token 206 can include, for its respective predetermined agent, one or more attributes or characteristics of the agent, including (but not limited to) the position of the agent in the driving environment, the size of the agent (e.g., length, width, and/or height, the velocity of the agent, the acceleration of the agent, the yaw of the agent, etc. An agent token 206 also may include trajectory and/or behavior data associated with its respective predetermined agent, including a planned driving path or trajectory for the agent, and a planned maneuver for the agent (e.g., U-turn, lane change, driveway or parking space pull-out, etc.). In some examples, the agent tokens 206 also may include previous and/or future state data associated with their respective agents, including any of the attributes or characteristics of the agent described herein at one or more previous timepoints or future timepoints relative to the current point in time of the synthetic driving scene 220.

The conditioning input data 204 also may include scene density tokens 208 indicating the number of additional agents that the diffusion model 120 should generate within the synthetic driving scene 220. In some examples, the conditioning input data 204 also may include one or more control policies 210 for use during a driving simulation (e.g., policies to associate with the synthetic driving scene data). In some cases, the map data 202 and/or conditioning input data 204 may include features of the environment, such as (but not limited to) roadway boundaries, roadway centerlines, crosswalk permissions, traffic light permissions, etc.

In various examples, the driving scene generator 102 may use one or more machine-learned models to output the conditioning input data 204 that is sent to the diffusion model 120. Such machine-learned models can, for example, include one or more self-attention layers for determining “attention” or a relationship between pairs or groups of agent tokens (e.g., cross-attention data between a first agent token and a second agent token), as well as determining attention between the agent tokens 206 and the scene density tokens 208. In such examples, the conditioning input data 204 can be generated using a transformer model or a GNN configured to generate cross-attention data between two or more agents in the driving environment, between agents and road features, agents and scene density tokens, etc.

In some examples, the driving scene generator 102 may provide the map data 202 and conditioning input data 204 to the diffusion model 120. The diffusion model 120 may be executed to de-noise a random noise sample into latent variable data 212, based at least in part on the map data 202 and the conditioning input data 204. The latent variable data 212 may represent different state data (e.g., positions, sizes, headings, trajectories, and the like) for the predetermined agents and any additional agents generated during de-noising by the diffusion model 120. In some examples, the diffusion model 120 may employ cross-attention techniques to determine relationships between the various agents and/or other objects in the synthetic driving scene 220. The diffusion model 120 can, for example, output the latent variable data 212 based at least in part on applying one or more cross-attention algorithms to the conditional input data 204.

The diffusion model 120 may be implemented as a machine-learned model configured to perform a diffusion process to add and/or remove noise from an input. For instance, the diffusion model 120 can incrementally de-noise data to generate an output based on one or more conditioning inputs. In some examples, the diffusion model 120 can de-noise the map data 202 (and/or other input data, token, random noise data, and the like) to output latent variables (e.g., the latent variable data 212) associated with one or more agents. The diffusion model 120 can also output latent variable data 212 representing behavior (e.g., states or intents) of one or more agents.

The variable autoencoder 214 may include an encoder 216 and a decoder 218 configured to provide a variety of functionality including generating occupancy data for one or more agents and/or objects within the synthetic driving scene 220. In various examples, the decoder may use the latent variable data 212 output by the diffusion model to generate bounding boxes, bounding contours, and/or heat map data for the various synthetic generated agents 222 and/or other objects in the synthetic driving scene 220. As discussed herein, occupancy data (or occupancies) may refer to discrete arrangements of agents with respect to a physical or simulated environment based on discretized templates of regions with respect to map data and/or the position of a vehicle within the map data. For example, details of determining occupancies within regions, clustering or organizing/arranging the occupancy data into hierarchies to model scenarios, are discussed in U.S. application Ser. No. 16/866,715, which is herein incorporated by reference in its entirety.

As shown in this example, the diffusion model 120 can generate the latent variable data 212 associated with different agents, that when processed by the decoder 218 of the variable autoencoder 214, causes the synthetic generated agents 222 to be added into or otherwise included in the synthetic driving scene 220. Typically, a variable autoencoder includes training a decoder to output data similar to an output of the encoder. Using the diffusion model 120 to condition the decoder 218 as described herein enables the decoder 218 to output data different from the output by the encoder 216 (e.g., determining agent representations based on the map data 202 and latent variable data 212).

In various examples, the encoder 216 and/or the decoder 218 can be implemented using machine-learned models, such as CNNs, GNNs, GANs, RNNs, transformer models, and the like. As discussed herein, the encoder 216 can be trained based at least in part on map data and agent/object occupancy data (e.g., bounding boxes, heat maps, etc.). The occupancy data can indicate an area of the environment in which objects are likely to be located. The decoder 218 can be trained based at least in part on a loss between the output of the decoder 218 and an output of the encoder 216. In some examples, the decoder 218 can be trained to improve a loss that takes into consideration the latent variable data 212 from the diffusion model 120.

FIG. 3 is a block diagram 300 illustrating an example diffusion model 120 implemented by a computing device to generate synthetic driving scenes, as described herein. In some examples, the techniques described in relation to FIG. 3 can be performed by a simulation system to generate and perform driving simulations. Additionally alternatively, the techniques described in relation to FIG. 3 can be performed by an autonomous vehicle while operating in a driving environment (e.g., a real-world environment or a simulated environment).

As described above in reference to FIG. 2, a driving scene generator 102 can implement a diffusion model 120 to generate latent variable data 212 for use by a machine-learned model, such as a variable autoencoder 214. As shown in this example, the diffusion model 120 may comprise latent space 302 for performing various steps (also referred to as operations) including adding noise to input data during training (shown as part of the diffusion process 320 in FIG. 3) and/or removing noise from input data during non-training (or inference) operations. The diffusion model 120 may receive conditioning data 304 for use during different diffusion steps to condition the input data, as discussed herein. For example, the conditioning data 304 can include one or more agent tokens 206, scene density tokens 208, and/or control policies 210 as described above. Additionally or alternatively, the conditioning data 304 may represent one or more semantic labels, text, images, object representations, object behaviors, vehicle representations, historical information associated with an agent and/or the vehicle, scene labels indicating level of difficulty to associate with a simulation, environment attributes, or object interactions, to name a few.

In some examples, agent tokens within the conditioning data 304 can include semantic labels, node information, and the like. Such agent tokens can include, for example, text or an image describing an agent. In some examples, agent tokens can be a representation and/or a behavior associated with one or more agents in an environment. Agent tokens also may include data describing an agent, such as whether another vehicle is using a blinker or a pedestrian is looking towards the autonomous vehicle. In a non-limiting example, the agent tokens within the conditioning data 304 can include specifying an agent behavior, such as a level of aggression for a simulation that includes an autonomous vehicle. The conditioning data 304 may also or instead represent environmental attributes such as weather conditions, traffic laws, time of day, and the like.

FIG. 3 depicts the variable autoencoder 214 associated with a pixel space 306 that includes an encoder 308 and a decoder 310. In some examples, the encoder 308 and the decoder 310 can represent an RNN or a multilayer perceptron (MLP). In some examples, the encoder 308 can receive an input (x) 312 representing a driving scene (e.g., map data, object/agent state data, agent trajectories, and/or other input data), and may output embedded information Z in the latent space 302. In some examples, the embedded information Z can include a feature vector for each agent in the driving scene. The feature vector may include data representing the current state of the agent, such as the agent position, size, pose, trajectory, type, and/or other attributes, etc. In some examples, the input (x) 312 can represent a top-down representation of an environment including a number of agents and/or other objects (e.g., which can be determined by the agent tokens 206 and/or other conditioning data 304). In some examples, the input (x) 312 can represent map data (e.g., map data 202) and/or occupancy data associated with a driving environment.

During training, the diffusion process 320 can perform an algorithm to apply noise to the embedded information Z to output a noisy latent embedding Z(T). When implementing the diffusion model 120 after training, the noisy latent embedding Z(T) (e.g., a representation of the input (x) 312) can be input into a de-noising neural network 314. The diffusion model 120 can initialize the noisy latent embedding Z(T) with random noise, and the de-noising neural network 314 (e.g., a CNN, a GNN, etc.) can apply one or more algorithms to determine an agent intent based on applying different noise for different passes, or steps, to generate latent variable data that represents an agent intent in the future. In some examples, multiple objects/agent and intents can be considered during denoising operations.

By way of example and not limitation, input to the de-noising neural network 314 can include a graph of nodes in which at least some nodes represent respective agents and/or other objects. In such examples, the input data can be generated with random features for each agent, and the de-noising neural network 314 can include performing graph message passing operations for one or more diffusion steps. In this way, the de-noising neural network 314 can determine an agent intent (e.g., an agent position, size, heading, trajectory, etc.) for an agent with consideration to the intent of other agents and/or objects. By performing multiple diffusion steps, potential interactions between agents and/or other objects can change over time to best reflect how a diverse set of agents and/or other objects may behave in a real-world environment.

The conditioning data 304 can be used by the diffusion model 120 in a variety of ways including being concatenated with the noisy latent embedding Z(T) as input into the de-noising neural network 314. In some examples, the conditioning data 304 can be input during a de-noising step 316 configured to apply a de-noising algorithm to an output of the de-noising neural network 314. The de-noising step 316 represents steps to apply the conditioning data 304 over time to generate the embedded information Z which can be output to the decoder 310 for use as initial states in a simulation that determines an output 318 representative of a synthetic driving scene including a number of agents and predicted agent state(s). As shown in this example, the agent tokens, scene density tokens, and/or other conditioning data 304 may be encoded using one or more encoders 322, and then provided to the de-noising neural network 314. Encoders 322 may be implemented, for example, using MLPs, transformers, etc., and configured to process the agent tokens and/or other conditioning data 304, before providing the collection of tokens to the de-noising neural network 314. In various examples, different encoders 322 may be used to process different types of tokens. For instance, a first transformer or MLP may be used to process agent tokens, while a second transformer or MLP may be used to process scene density tokens. When different types of agent tokens are implemented to support many-to-one relationships between agent tokens and agents, the encoders 322 may include different transformers/MLPs to process the different types of agent tokens. For instance, a first transformer or MLP may be used to process agent tokens representing agent position and size, while a second transformer or MLP may be used to process agent tokens representing agent trajectories, etc.

A training component, described below in more detail, can train the diffusion model 120 based at least in part on a computed loss for the decoder 310 (e.g., the ability for the decoder to produce an output that is similar to the input to the encoder). That is, the diffusion model 120 can improve predictions over time based on being trained at least in part on a loss associated with the decoder 310. In some examples, the decoder 310 can be trained based at least in part on a loss associated with the diffusion model 120.

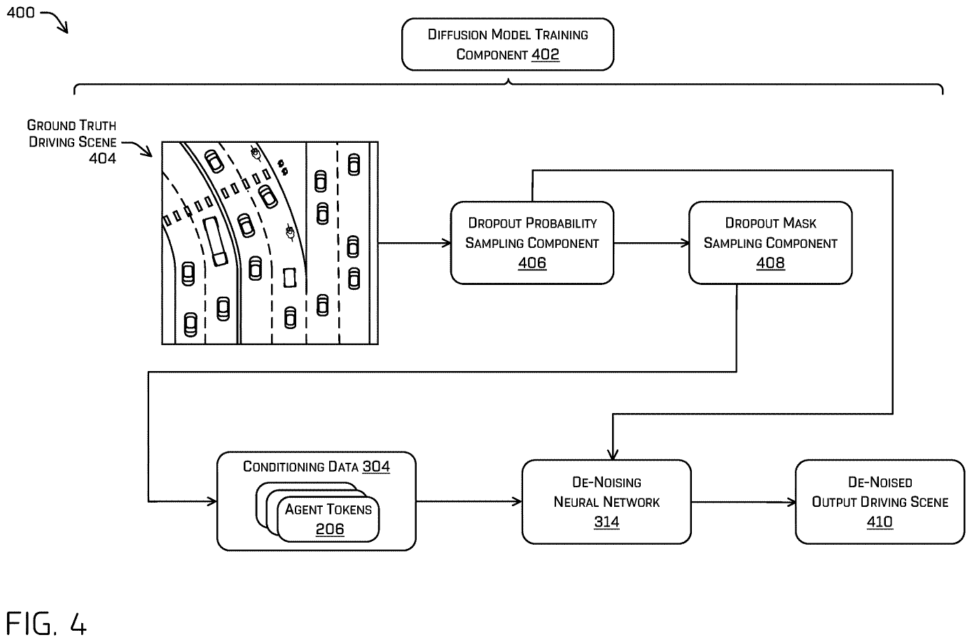

FIG. 4 is a block diagram 400 illustrating a technique for training a diffusion model (e.g., diffusion model 120) to generate synthetic driving scenes. As noted above, training diffusion models generally may include performing a diffusion process in which noise is added to a ground truth sample (e.g., a ground truth driving scene), after which the diffusion model is executed (e.g., using a de-noising neural network 314 and associated cross-attention layers to provide conditioning data) to de-noise the ground truth sample. Loss data may be computed based on how effectively and accurately the diffusion model de-noises the ground truth sample (e.g., based on differences between the original and de-noised ground truth sample), and the diffusion model may be trained based on the loss data from any number of training processes.

After training a diffusion model, the diffusion model may be used to generate realistic synthetic samples (e.g., synthetic driving scenes) based on random noise samples. For example, a randomly generated noise sample may be iteratively de-noised (e.g., using the de-noising neural network 314 and conditioning data), to generate a realistic synthetic driving scene that is conditioned based on the map data, one or more agent tokens, scene density tokens, and/or other conditioning data.

In this example, FIG. 4 depicts an example of a training process for a diffusion model 120 trained to generate synthetic driving scenes. As shown in this example, a diffusion model training component 402 may be implemented to perform the training process. The diffusion model training component 402 may be incorporated into or associated with the driving scene generator 102 and/or with a simulation system such as the driving simulation system 740 described below in reference to FIG. 7.

To perform a training process (or training operation) on the diffusion model 120, the diffusion model training component 402 initially may receive a ground truth driving scene 404. As noted above, the ground truth driving scene 404 may be based on real-world driving data (e.g., log data) captured by sensors of a vehicle driving in a real or simulated environment. The ground truth driving scene 404 may be provided to the diffusion model training component in various data structures and/or formats, for example, as a top-down image and/or other sensor data, a top-down multi-channel representation including labeled bounding box representations of agents, etc.

The diffusion model training component 402 may include a dropout probability sampling component 406 configured to determine a dropout probability for the ground truth driving scene 404. The dropout probability may represent an amount (e.g., percentage) of the agents within the ground truth driving scene 404 to be dropped out (or masked out) during the diffusion process. The dropout probability sampling component 406 may use any number of techniques to determine a dropout probability, including (but not limited to) sampling a random dropout probability between 0% and 100%.

After determining a dropout probability, the diffusion model training component 402 may use a dropout mask sampling component 408 to determine a dropout mask to apply to the ground truth driving scene 404. For example, the dropout mask sampling component 408 may use sampling techniques based on the dropout probability, to determine a dropout mask to apply to a driving scene. In some cases, dropout probability can be applied individually to each agent in the ground truth driving scene 404, so that each agent has a N% probability of being masked out during the diffusion process. Additionally or alternatively, the dropout mask sampling component 408 may determine a random subset of the agents within the ground truth driving scene 404 to mask out, based on the dropout probability.

The dropout mask determined by the dropout mask sampling component 408 may be applied to the ground truth driving scene 404, to determine a set of agent tokens 206 to use in training the diffusion model 120. Using the techniques described above, the agent tokens 206 then may be provided to the de-noising neural network 314. As described above, the de-noising neural network 314 may be configured to perform an iterative de-noised process, to output a de-noised driving scene from an input noise sample, where the conditioning data 304 (including agent tokens 206) is used to condition the iterative de-noising process. The result of the conditioned de-noising process performed with the de-noising neural network 314 may represent a de-noised output driving scene 410, which may (but need not) be populated with one or more additional agents. In some examples, the diffusion model 120 may include associated cross-attention layers used to provide conditioning data 304 to the de-noising neural network 314. As shown in this example, the de-noising neural network 314 also may receive the dropout probability used to diffuse the ground truth driving scene 404, thereby allowing the de-noising neural network 314 to learn to de-denoise the driving scene in a manner consistent with the ground truth scene density.

Although the above examples describe using the dropout mask sampling component 408 to mask out particular objects (e.g., agents) from a driving scene, in other examples the dropout mask sampling component 408 may use similar techniques to determine and mask out individual features of an object. For instance, the dropout probability sampling component 406 and the dropout mask sampling component 408 may be used to determine and mask out one or more individual agent features or attributes (e.g., location, size, heading, velocity, type, and/or trajectory, etc.), while retaining other features/attributes of the agent for the subsequent agent token 206.

The training process described in this example may be performed any number of times, based on the ground truth driving scene 404 and/or a number of additional ground truth driving scenes. In some examples, multiple training processes may be executed based on the same ground truth driving scene, by sampling different (e.g., random) dropout probabilities, and/or different dropout masks based on the dropout probabilities, thereby robustly training the diffusion model 120 to effectively perform de-noising for cases of different dropout probabilities and different configurations of masked agents.

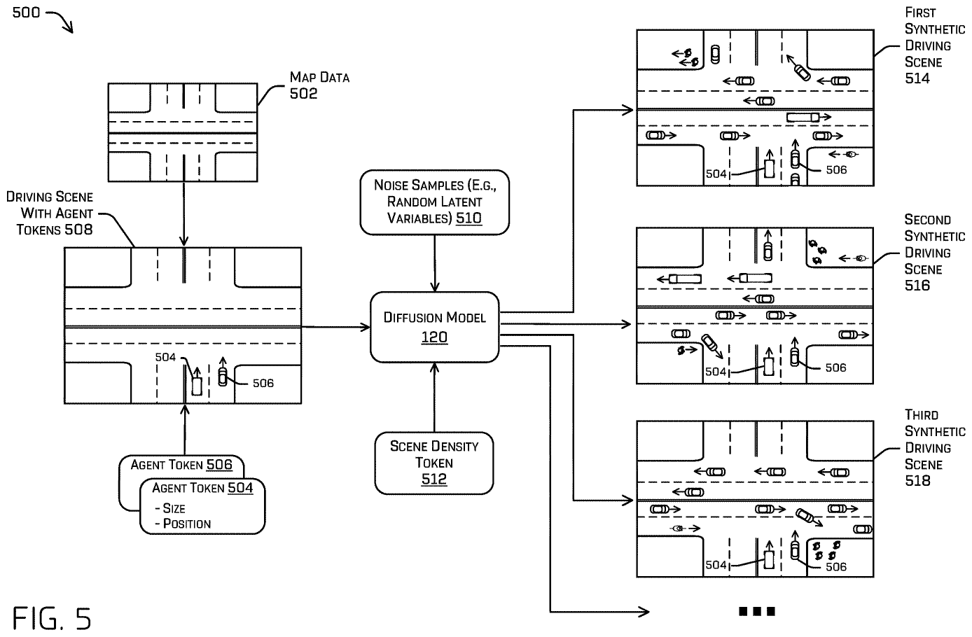

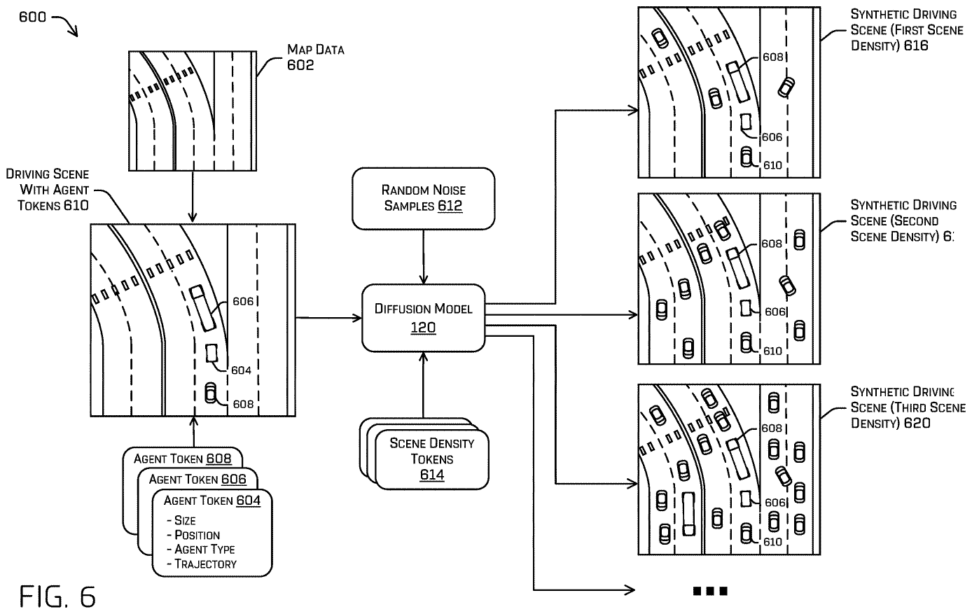

FIG. 5 and FIG. 6 represent techniques of using a diffusion model 120 to generate multiple different synthetic driving scenes. As noted above, because the diffusion model 120 (along with the variable autoencoder 214 and additional related components described herein) may be trained to generate synthetic driving scenes from random noise samples, the diffusion model 120 can be used to generate any number of realistic driving scenes based on the same map data and the same set of agent tokens defining the same initial set of predetermined agents.

For example, FIG. 5 depicts a diagram 500 illustrating an example technique of using a diffusion model 120 to generate multiple synthetic driving scenes based on random noise samples. As shown in this example, the diffusion model 120 may be provided with conditioning data, based on map data 502 and two agent tokens 504-506 representing two agents in a specific predetermined configuration. In this example, a user (or other client system) has provided the driving scene generator 102 with characteristics for two predetermined agents. Based on the predetermined agent characteristics, the driving scene generator 102 has determined two agent tokens 504-506: a first agent token 504 representing the vehicle to be validated in a simulation based on the driving scene; and a second agent token 506 representing a second vehicle positioned just in front and in the lane to the right of the first vehicle. For illustrative purposes, an example driving scene 508 is shown based on a predetermined configuration of the map data 502 and the two agent tokens 504-506. As shown in this example, the diffusion model 120 also may receive a scene density token 512 indicating a dropout percentage and/or a number of agents for the diffusion model 120 to generate.

The diffusion model 120 then may receive and de-noise any number of random noise samples 510 into distinct but realistic synthetic driving scenes. Based on the map data 502, the agent tokens 504-506, and/or the scene density token 512 (e.g., any or all of which may be provided to the diffusion model 120 as conditioning inputs via a cross-attention mechanism), the diffusion model 120 may generate a unique synthetic driving scene based on each random noise sample 510. As shown in this example, the diffusion model 120 (along with the variable autoencoder 214) may generate a first synthetic driving scene 514 based on a first random noise sample, a second synthetic driving scene 514 based on a second random noise sample, and a third synthetic driving scene 516 based on a third random noise sample. The diffusion model 120 (along with a variable autoencoder 214) may perform iterative de-noising operations, so that the latent embeddings for each synthetic driving scene may develop independently as the corresponding random noise sample is de-noised. As a result, each of the synthetic driving scenes generated by the diffusion model 120 may be unique and independent, while also representing realistic real-world driving scenes that include the desired configuration of predetermined agents.

Additionally, FIG. 6 depicts another diagram 600 illustrating another example technique of using a diffusion model 120 to generate multiple synthetic driving scenes based on random noise samples. As in the previous example, the diffusion model 120 shown in FIG. 6 may be provided with map data 602 and a fixed set of agent tokens 604-608 representing agents in a specific predetermined configuration. In this example, a user (or other client system) has provided the driving scene generator 102 with characteristics for three predetermined agents. Based on the predetermined agent characteristics, the driving scene generator 102 has determined three agent tokens 604-608: a first agent token 604 representing the vehicle to be validated in a simulation based on the driving scene; a second agent token 606 representing a truck driving in front of the vehicle; and a third agent token 608 representing another vehicle driving closely behind the vehicle. The predetermined configuration of the map data 602 and the three agent tokens 604-608 is shown in the driving scene 610.

In this example, the driving scene generator 102 may use different scene density tokens 614, indicating different dropout percentages (and/or different numbers of agents for the diffusion model 120 to generate), when using the diffusion model 120 to generate synthetic driving scenes. For instance, the driving scene generator 102 may provide the diffusion model 120 with one or more random noise samples 612, along with the map data 602, the agent tokens 604-608, and a selected one of the scene density token 614 (e.g., any or all of which may be provided to the diffusion model 120 as conditioning inputs via a cross-attention mechanism). Based on the map data 602, conditioning inputs (e.g., agent tokens 604-608, scene density tokens 614), and the diffusion model 120 may generate a different unique synthetic driving scenes based on one or more random noise samples 612. As shown in this example, the diffusion model 120 (along with the variable autoencoder 214) may use the same random noise sample 612 to generate three different synthetic driving scenes having different scene densities. The first synthetic driving scene 616 may be output by the diffusion model 120 (e.g., via the variable autoencoder 214) based on a random noise sample 612 and using a first scene density token 614 requesting a low-density driving scene. The second synthetic driving scene 618 may be output by the diffusion model 120 based on the same (or a different) random noise sample 612 and using a second scene density token 614 requesting a medium-density driving scene. The third synthetic driving scene 620 may be output by the diffusion model 120 based on the same (or a different) random noise sample 612 and using a third scene density token 614 requesting a high-density driving scene. As in the previous examples, the diffusion model 120 in FIG. 6 (along with a variable autoencoder 214) may perform iterative de-noising operations, so that the latent embeddings for each synthetic driving scene may develop independently as the random noise sample is de-noised. As a result, each of the synthetic driving scenes generated by the diffusion model 120 may be unique and independent, while also representing realistic real-world driving scenes, including the desired configuration of predetermined agents and the desired scene density.

FIG. 7 illustrates an example computing environment 700 that may be used to implement the techniques described herein for generating synthetic driving scenes, and generating and performing driving simulations. In this example, the computing environment 700 includes a vehicle 702 and computing device(s) 732 configured to generate synthetic driving scenes, and to execute and evaluate driving simulations based on the driving scenes. The vehicle 702 may include various software-based and/or hardware-based components of an autonomous vehicle, and may be used to control autonomous vehicles traversing through physical environments and/or simulated vehicles operating within log-based driving simulations. The vehicle 702 may be similar or identical to any or all of the real and/or simulated vehicles or vehicle controllers described herein. The computing device(s) 732 may be similar or identical to the computing devices of the driving scene generator 102, diffusion model training component 402, and simulation systems described above in reference to FIGS. 1-6. In some examples, the vehicle 702 may correspond to a vehicle traversing a physical environment, capturing and storing log data which may be provided to the computing device(s) 732 and used to generate synthetic driving scenes. Additionally or alternatively, the vehicle 702 may operate as one or more separate vehicle control systems, interacting with and being evaluated by the computing device(s) 732 during a driving simulation.

In at least one example, the vehicle 702 may correspond to an autonomous or semi-autonomous vehicle configured to perform object perception and prediction functionality, route planning and/or optimization. The example vehicle 702 can be a driverless vehicle, such as an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such examples, because the vehicle 702 can be configured to control all functions from start to completion of the trip, including all parking functions, it may not include a driver and/or controls for driving the vehicle 702, such as a steering wheel, an acceleration pedal, and/or a brake pedal. This is merely an example, and the systems and methods described herein may be incorporated into any ground-borne, airborne, or waterborne vehicle, including those ranging from vehicles that need to be manually controlled by a driver at all times, to those that are partially or fully autonomously controlled.

The vehicle 702 may include vehicle computing device(s) 704, sensor(s) 706, emitter(s) 708, network interface(s) 710, at least one direct connection 712 (e.g., for physically coupling with the vehicle to exchange data and/or to provide power), and one or more drive system(s) 714. In this example, the vehicle 702 may correspond to vehicle 702 discussed above. The system 700 may additionally or alternatively comprise vehicle computing device(s) 704.

In some instances, the sensor(s) 706 may include lidar sensors, radar sensors, ultrasonic transducers, sonar sensors, location sensors (e.g., global positioning system (GPS), compass,), inertial sensors (e.g., inertial measurement units (IMUs), accelerometers, magnetometers, gyroscopes,), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors,), etc. The sensor(s) 706 may include multiple instances of each of these or other types of sensors. For instance, the radar sensors may include individual radar sensors located at the corners, front, back, sides, and/or top of the vehicle 702. As another example, the cameras may include multiple cameras disposed at various locations about the exterior and/or interior of the vehicle 702. The sensor(s) 706 may provide input to the vehicle computing device(s) 704 and/or to computing device(s) 732.

The vehicle 702 may also include emitter(s) 708 for emitting light and/or sound, as described above. The emitter(s) 708 in this example may include interior audio and visual emitter(s) to communicate with passengers of the vehicle 702. By way of example and not limitation, interior emitter(s) may include speakers, lights, signs, display screens, touch screens, haptic emitter(s) (e.g., vibration and/or force feedback), mechanical actuators (e.g., seatbelt tensioners, seat positioners, headrest positioners,) , and the like. The emitter(s) 708 in this example may also include exterior emitter(s). By way of example and not limitation, the exterior emitter(s) in this example include lights to signal a direction of travel or other indicator of vehicle action (e.g., indicator lights, signs, light arrays,), and one or more audio emitter(s) (e.g., speakers, speaker arrays, horns,) to audibly communicate with pedestrians or other nearby vehicles, one or more of which comprising acoustic beam steering technology.

The vehicle 702 may also include network interface(s) 710 that enable communication between the vehicle 702 and one or more other local or remote computing device(s). For instance, the network interface(s) 710 may facilitate communication with other local computing device(s) on the vehicle 702 and/or the drive systems(s) 714. Also, the network interface(s) 710 may additionally or alternatively allow the vehicle to communicate with other nearby computing device(s) (e.g., other nearby vehicles, traffic signals, etc.). The network interface(s) 710 may additionally or alternatively enable the vehicle 702 to communicate with computing device(s) 732. In some examples, computing device(s) 732 may comprise one or more nodes of a distributed computing system (e.g., a cloud computing architecture).

The network interface(s) 710 may include physical and/or logical interfaces for connecting the vehicle computing device(s) 704 to another computing device or a network, such as network(s) 734. For example, the network interface(s) 710 may enable Wi-Fi-based communication such as via frequencies defined by the IEEE 200.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s). In some instances, the vehicle computing device(s) 704 and/or the sensor(s) 706 may send sensor data, via the network(s) 734, to the computing device(s) 732 at a particular frequency, after a lapse of a predetermined period of time, in near real-time, etc.

In some instances, the vehicle 702 may include one or more drive systems(s) 714 (or drive components). In some instances, the vehicle 702 may have a single drive system 714. In some instances, the drive system(s) 714 may include one or more sensors to detect conditions of the drive system(s) 714 and/or the surroundings of the vehicle 702. By way of example and not limitation, the sensor(s) of the drive systems(s) 714 may include one or more wheel encoders (e.g., rotary encoders) to sense rotation of the wheels of the drive components, inertial sensors (e.g., inertial measurement units, accelerometers, gyroscopes, magnetometers) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive systems(s) 714. In some cases, the sensor(s) on the drive systems(s) 714 may overlap or supplement corresponding systems of the vehicle 702 (e.g., sensor(s) 706).

The drive systems(s) 714 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive systems(s) 714 may include a drive component controller which may receive and preprocess data from the sensor(s) and to control operation of the various vehicle systems. In some instances, the drive component controller may include one or more processors and memory communicatively coupled with the one or more processors. The memory may store one or more components to perform various functionalities of the drive systems(s) 714. Furthermore, the drive systems(s) 714 may also include one or more communication connection(s) that enable communication by the respective drive component with one or more other local or remote computing device(s).

The vehicle computing device(s) 704 may include processor(s) 716 and memory 718 communicatively coupled with the one or more processors 716. Computing device(s) 732 may also include processor(s) 736, and/or memory 738. As described above, the memory 738 of the computing device(s) 732 may store and execute a driving scene generator 102 including one or more diffusion model(s) 120 and variable autoencoder(s) 214, as well as a driving simulation system 740 configured to generate and perform driving simulations. Additional examples of techniques for using a driving simulation system 740 to generate and perform driving simulations can be found, for example, in U.S. patent application Ser. No. 16/708,019, filed Dec. 9, 2019, and titled “Perception Error Models,” in U.S. patent application Ser. No. 16/798,073, filed Feb. 21, 2020, and titled “Synthetic Scenario Generator Using Distance-Biased Confidences For Sensor Data,” and in U.S. patent application Ser. No. 17/459,214, filed Aug. 27, 2021, and titled “Synthetic Generation Of Simulation Scenarios And Probability-Based Simulation Evaluation,” each of which are incorporated by reference herein, in their entirety, for all purposes.

The processor(s) 716 and/or 736 may be any suitable processor capable of executing instructions to process data and perform operations as described herein. By way of example and not limitation, the processor(s) 716 and/or 736 may comprise one or more central processing units (CPUs), graphics processing units (GPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 718 and/or 738 may be examples of non-transitory computer-readable media. The memory 718 and/or 738 may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 718 and/or memory 738 may store a localization component 720, perception component 722, maps 724, system controller(s) 726, prediction component 728, and/or planning component 730.

In at least one example, the localization component 720 may include hardware and/or software to receive data from the sensor(s) 706 to determine a position, velocity, and/or orientation of the vehicle 702 (e.g., one or more of an x-, y-, z-position, roll, pitch, or yaw). For example, the localization component 720 may include map(s) of an environment and can continuously determine a location, velocity, and/or orientation of the autonomous vehicle within the map(s). In some instances, the localization component 720 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some instances, the localization component 720 may provide data to various components of the vehicle 702 to determine an initial position of an autonomous vehicle for generating a trajectory and/or for generating map data, as discussed herein. In some examples, localization component 720 may provide, to the planning component 730 and/or to the prediction component 728, a location and/or orientation of the vehicle 702 relative to the environment and/or sensor data associated therewith.

The memory 718 can further include one or more maps 724 that can be used by the vehicle 702 to navigate within the environment. For the purpose of this discussion, a map can be any number of data structures modeled in two dimensions, three dimensions, or N-dimensions that are capable of providing information about an environment, such as, but not limited to, topologies (such as intersections), streets, mountain ranges, roads, terrain, and the environment in general. In one example, a map can include a three-dimensional mesh generated using the techniques discussed herein. In some instances, the map can be stored in a tiled format, such that individual tiles of the map represent a discrete portion of an environment, and can be loaded into working memory as needed. In at least one example, the one or more maps 724 may include at least one map (e.g., images and/or a mesh) generated in accordance with the techniques discussed herein. In some examples, the vehicle 702 can be controlled based at least in part on the maps 724. That is, the maps 724 can be used in connection with the localization component 720, the perception component 722, and/or the planning component 730 to determine a location of the vehicle 702, identify objects in an environment, and/or generate routes and/or trajectories to navigate within an environment.

In some instances, the perception component 722 may comprise a primary perception system and/or a prediction system implemented in hardware and/or software. The perception component 722 may detect object(s) in in an environment surrounding the vehicle 702 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. Data determined by the perception component 722 may be referred to as perception data.

In some examples, sensor data and/or perception data may be used to generate an environment state that represents a current state of the environment. For example, the environment state may be a data structure that identifies object data (e.g., object position, area of environment occupied by object, object heading, object velocity, historical object data), environment layout data (e.g., a map or sensor-generated layout of the environment), environment condition data (e.g., the location and/or area associated with environmental features, such as standing water or ice, whether it's raining, visibility metric), sensor data (e.g., an image, point cloud), etc. In some examples, the environment state may include a top-down two-dimensional representation of the environment and/or a three-dimensional representation of the environment, either of which may be augmented with object data. In yet another example, the environment state may include sensor data alone. In yet another example, the environment state may include sensor data and perception data together.

The prediction component 728 may include functionality to generate predicted information associated with objects in an environment. As an example, the prediction component 728 can be implemented to predict locations of a pedestrian proximate to a crosswalk region (or otherwise a region or location associated with a pedestrian crossing a road) in an environment as they traverse or prepare to traverse through the crosswalk region. As another example, the techniques discussed herein can be implemented to predict locations of other objects (e.g., vehicles, bicycles, pedestrians, and the like) as the vehicle 702 traverses an environment. In some examples, the prediction component 728 can generate one or more predicted positions, predicted velocities, predicted trajectories, etc., for such target objects based on attributes of the target object and/or other objects proximate the target object.

The planning component 730 may receive a location and/or orientation of the vehicle 702 from the localization component 720, perception data from the perception component 722, and/or predicted trajectories from the prediction component 728, and may determine instructions for controlling operation of the vehicle 702 based at least in part on any of this data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic) that the system controller(s) 726 and/or drive systems(s) 714 may parse/cause to be carried out, second instructions for the emitter(s) 708 may be formatted according to a second format associated therewith). In at least one example, the planning component 730 may comprise a nominal trajectory generation subcomponent that generates a set of candidate trajectories, and selects a trajectory for implementation by the drive systems(s) 714 based at least in part on determining a cost associated with a trajectory according to U.S. patent application Ser. No. 16/517,506, filed Jul. 19, 2019 and/or U.S. patent application Ser. No. 16/872,284, filed May 11, 2020, the entirety of which are incorporated herein for all purposes.

The memory 718 and/or 738 may additionally or alternatively store a mapping system (e.g., generating a map based at least in part on sensor data), a planning system, a ride management system, etc. Although localization component 720, perception component 722, the prediction component 728, the planning component 730, and/or system controller(s) 726 are illustrated as being stored in memory 718, any of these components may include processor-executable instructions, machine-learned model(s) (e.g., a neural network), and/or hardware and all or part of any of these components may be stored on memory 738 or configured as part of computing device(s) 732.

As described herein, the localization component 720, the perception component 722, the prediction component 728, the planning component 730, and/or other components of the system 700 may comprise one or more ML models. For example, the localization component 720, the perception component 722, the prediction component 728, and/or the planning component 730 may each comprise different ML model pipelines. The prediction component 728 may use a different ML model or a combination of different ML models in different circumstances. For example, the prediction component 728 may use different GNNs, RNNs, CNNs, MLPs and/or other neural networks tailored to outputting predicted agent trajectories in different seasons (e.g., summer or winter), different driving conditions and/or visibility conditions (e.g., times when border lines between road lanes may not be clear or may be covered by snow), and/or based on different crowd or traffic conditions (e.g., more conservative trajectories in a crowded traffic conditions such as downtown areas, etc.). In various examples, any or all of the above ML models may comprise an attention mechanism, GNN, and/or any other neural network. An exemplary neural network is a biologically inspired algorithm which passes input data through a series of connected layers to produce an output. Each layer in a neural network can also comprise another neural network, or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3(ID 3 ), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, and the like.

Memory 718 may additionally or alternatively store one or more system controller(s) 726, which may be configured to control steering, propulsion, braking, safety, emitters, communication, and other systems of the vehicle 702. These system controller(s) 726 may communicate with and/or control corresponding systems of the drive systems(s) 714 and/or other components of the vehicle 702.

It should be noted that while FIG. 7 is illustrated as a distributed system, in alternative examples, components of the vehicle 702 may be associated with the computing device(s) 732 and/or components of the computing device(s) 732 may be associated with the vehicle 702. That is, the vehicle 702 may perform one or more of the functions associated with the computing device(s) 732, and vice versa.

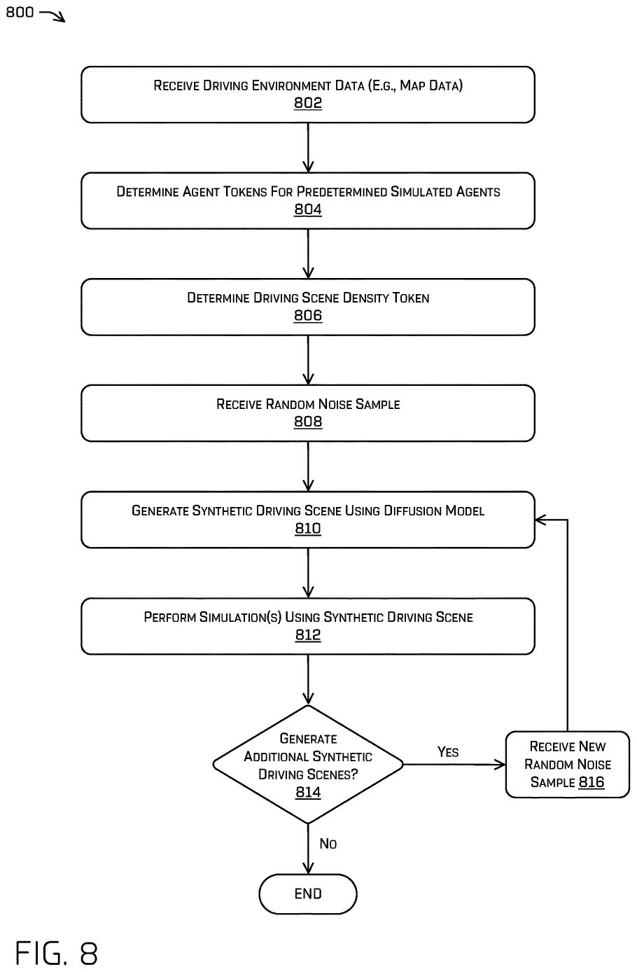

FIG. 8 is a flow diagram illustrating an example process 800 for generating synthetic driving scenes, and executing driving simulations based on the synthetic driving scenes. As described below, process 800 may be performed by one or more computer-based components configured to implement various functionalities described herein. For instance, process 800 may be performed by a driving scene generator 102 including (or associated with) a diffusion model 120 and variable autoencoder 214 trained to generate synthetic driving scenes by using diffusion techniques to de-noise random noise samples. Additionally or alternatively, some or all process 800 may be performed by a driving simulation system 740 configured to generate and perform driving simulations based on synthetic driving scenes, to test and validate the systems and features of autonomous vehicles.

Process 800 is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types. The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

At operation 802, the driving scene generator 102 may receive data representing a driving environment (e.g., map data) for the synthetic driving scene to be generated. In various examples, map data received in operation 802 may include image data, top-down multi-channel representations, and/or any number of data structures capable of providing information about a driving environment. The map data may include, but is not limited to, road network topologies including streets and intersections, drivable surface data, sidewalks, driveways, curbs, crosswalks, traffic signs and signals, lane data, road marking, road condition data, etc. In some cases, the map data may correspond to real-world map data captured by sensors of a vehicle, received from a map server, captured from a surveillance camera or satellite image, etc. In other cases, the map data may be synthetically generated and need not correspond to a real-world driving environment.

At operation 804, the driving scene generator 102 may determine any number of agent tokens based on predetermined agent data received by a user and/or other client system. As described above, the predetermined agent data may define a desired configuration of agents, including the vehicle to be validated during simulation and one or more additional agents proximate to the vehicle in the driving environment. The driving scene generator 102 may determine agent tokens such that the agent tokens have a one-to-one relationship with the predetermined set of agents to be included in the synthetic driving scene. As a result, each agent token provided to the diffusion model may represent a single predetermined agent. In some examples, agent tokens may be generated as feature vectors, using a domain-specific language that may describe any number of characteristics of an agent in a driving environment (e.g., agent size, location, heading, type, velocity, trajectory, etc.). Agent tokens also may be generated using various different levels of granularity in different examples (e.g. pixel-level agent data versus broader agent data).

At operation 806, the driving scene generator 102 may determine a scene density token based on a desired scene density of the synthetic driving scene to be generated. In some examples, the scene density token may be determined based on input from a user indicating the desired scene density and/or a number of additional agents to be added to the synthetic driving scene. Additionally or alternatively, the driving scene generator 102 may randomly determine a desired scene density, or may be configured to generate multiple different synthetic driving scenes based on the same map data and same agent tokens, but having different levels of scene density.

At operation 808, the driving scene generator 102 may receive a random noise sample, and at operation 810, the driving scene generator 102 may generate the synthetic driving scene, by using the diffusion model 120 to de-noise the random noise sample. As described herein, the diffusion model 120 may generate and output latent variable data to a decoder of a trained variable autoencoder 214. The decoder may generate the synthetic driving scene using the map data and the latent variable data output by the diffusion model. The latent variable data may represent different state data (e.g., positions, sizes, headings, trajectories, and the like) for the predetermined agents and any additional agents generated during de-noising by the diffusion model. In some examples, the diffusion model 120 may generate the latent variable data associated with different agents, that when processed by the decoder of the variable autoencoder 214, causes the synthetic generated agents to be added into or otherwise included in the synthetic driving scene. Additionally, as noted above, the diffusion model 120 may include a de-noising component (e.g., a trained de-noising neural network), and may include associated cross-attention layers used to provide conditioning data to the de-noising component. The de-noising component may be configured to perform iterative de-noising steps, and also may receive the scene density token, thereby allowing the de-noising component de-denoise the driving scene in a manner consistent with the requested or required scene density.

At operation 812, the driving scene generator 102 may perform one or more driving simulations (and/or may initiate driving simulations to be performed on a separate driving simulation system 740), using the synthetic driving scene generated by the diffusion model 120 (and/or variable autoencoder 214) in operation 810. The driving simulations performed in operation 812 may include individual simulations or larger simulation batteries configured to validate the responses of an autonomous vehicle to various simulation scenarios involving the synthetic driving scene. In some examples, a driving simulation system 740 can execute a simulated scenario on the synthetic driving scene, including generating simulation data that indicates how an autonomous vehicle controller and/or other objects would respond given the simulated scenario.

At operation 814, the driving scene generator 102 may determine whether or not to generate additional synthetic driving scenes. For instance, when additional driving scenes are requested or required for obtaining additional simulation coverage of an autonomous vehicle controller (814: Yes), the driving scene generator 102 may receive (e.g., generate) an additional random noise sample at operation 816. Additionally or alternatively, when additional synthetic driving scenes are needed (814: Yes), the driving scene generator 102 may alter the scene density token to request a higher or lower density of synthetic driving scene. In such cases, additionally or alternatively, the driving scene generator 102 also may modify and/or replace the map data associated with the driving scene, and/or the agent tokens representing the predetermined configuration of agents to be included in the synthetic driving scene.

### EXAMPLE CLAUSES

A. A system comprising: one or more processors; and one or more non-transitory computer-readable media storing computer-executable instructions that, when executed, cause the one or more processors to perform operations comprising: receiving data representing a driving environment; determining a first token including a feature vector representing agent attribute data, the agent attribute data including at least an agent position in the driving environment; determining a second token representing at least one of: a number of additional agents to be generated in a synthetic driving scene; or a density metric associated with the synthetic driving scene; providing, to a diffusion model, the data representing the driving environment, the first token, and the second token; generating, based at least in part on an output of the diffusion model, the synthetic driving scene including a first agent associated with the first token and at least one additional agent, wherein the diffusion model is trained to position the at least one additional agent in the synthetic driving scene based at least in part on the first token; and performing a driving simulation based at least in part on the synthetic driving scene.

B. The system of paragraph A, wherein the diffusion model is configured to iteratively apply a de-noising algorithm to generate the synthetic driving scene based on a noise sample.

C. The system of paragraph A, the operations further comprising: determining a third token representing a second agent to be generated in the synthetic driving scene, the third token including a second feature vector representing at least a size of the second agent and a position of the second agent in the driving environment, wherein: the diffusion model is trained to generate the at least one additional agent within the synthetic driving scene based at least in part on the first token and the third token.

D. The system of paragraph A, wherein: the feature vector of the first token further includes data representing at least one of a first trajectory or a first driving behavior associated with the first agent.

E. The system of paragraph D, wherein the diffusion model is trained to determine a position for the at least one additional agent in the synthetic driving scene, based at least in part on the first trajectory or the first driving behavior associated with the first agent.

F. A method comprising: receiving, by a scene generator, data representing a driving environment; determining, by the scene generator, a first token describing a first object attribute; and generating, using a generative model, scene data based at least in part on the driving environment and the first token, the scene data representing a driving scene including a first object based on the first token and an additional object, wherein the generative model is trained to generate the first object and the additional object within the driving scene based at least in part on the first token.

G. The method of paragraph F, wherein the first token includes a feature vector representing: a size of the first object; a position of the first object; and a heading of the first object.

H. The method of paragraph F, further comprising: determining, by the scene generator, a second token describing a second object attribute, wherein: the first token is associated with the first object in the driving scene; the second token is associated with a second object to be generated in the driving scene; and the generative model is trained to generate the additional object within the driving scene based at least in part on the first token and the second token.

I. The method of paragraph H, wherein: the first token includes data representing a first set of attributes associated with the first object; and the second token includes data representing a second set of attributes associated with the second object, wherein the first set of attributes is different from the second set of attributes.

J. The method of paragraph F, further comprising: determining, by the scene generator, a second token representing at least one of: a number of additional objects to be generated by the generative model; or a density metric associated with the driving scene.

K. The method of paragraph F, wherein the first token includes data representing: a first position within the driving environment at which the first object is to be generated; and a first trajectory associated with the first object.

L. The method of paragraph K, wherein the generative model is configured to determine a second position for the additional object within the driving environment, based at least in part on the first trajectory associated with the first object.

M. The method of paragraph F, further comprising: generating, using the generative model, second scene data based at least in part on the driving environment and the first token, the second scene data representing a second driving scene different from the driving scene, wherein: generating the scene data comprises providing, to the generative model, a first noise sample, the data representing a driving environment, and the first token; and generating the second scene data comprises providing, to the generative model, a second noise sample, the data representing a driving environment, and the first token.

N. The method of paragraph M, wherein the driving scene includes a first set of objects and the second driving scene includes a second set of objects, and wherein the method further comprises: performing a first driving simulation, based at least in part on the first driving scene, to simulate potential interactions between a vehicle and the first set of objects in the driving environment; and performing a second driving simulation, based at least in part on the second driving scene, to simulate potential interactions between the vehicle and the second set of objects in the driving environment.

O. One or more non transitory computer readable media storing instructions executable by a processor, wherein the instructions, when executed, cause the processor to perform operations comprising: receiving, by a scene generator, data representing a driving environment; determining, by the scene generator, a first token describing a first object attribute; and generating, using a generative model, scene data based at least in part on the driving environment and the first token, the scene data representing a driving scene including a first object based on the first token and an additional object, wherein the generative model is trained to generate the first object and the additional object within the driving scene based at least in part on the first token.

P. The one or more non transitory computer readable media of paragraph O, wherein the first token includes a feature vector representing: a size of the first object; a position of the first object; and a heading of the first object.

Q. The one or more non transitory computer readable media of paragraph O, the operations further comprising: determining, by the scene generator, a second token describing a second object attribute, wherein: the first token is associated with the first object in the driving scene; the second token is associated with a second object to be generated in the driving scene; and the generative model is trained to generate the additional object within the driving scene based at least in part on the first token and the second token.

R. The one or more non transitory computer readable media of paragraph Q, wherein: the first token includes data representing a first set of attributes associated with the first object; and the second token includes data representing a second set of attributes associated with the second object, wherein the first set of attributes is different from the second set of attributes.

S. The one or more non transitory computer readable media of paragraph O, further comprising: determining, by the scene generator, a second token representing at least one of: a number of additional objects to be generated by the generative model; or a density metric associated with the driving scene.

T. The one or more non transitory computer readable media of paragraph O, wherein the first token includes data representing: a first position within the driving environment at which the first object is to be generated; and a first trajectory associated with the first object.

While the example clauses described above are described with respect to particular implementations, it should be understood that, in the context of this document, the content of the example clauses can be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

1. A system comprising:
one or more processors; and
one or more non-transitory computer-readable media storing computer-executable instructions that, when executed, cause the one or more processors to perform operations comprising:
receiving data representing a driving environment for a synthetic driving scene to be generated;
receiving agent data representing an attribute of a synthetic agent to be generated in the synthetic driving scene;
determining, based at least in part on the agent data, agent token of an agent token type, the first agent token including a feature vector representing agent attribute data of the synthetic agent to be generated;
receiving desired scene density data for the synthetic driving scene to be generated;
determining, based at least in part on the desired scene density data, a second density token of a scene density token type;
providing, to a diffusion model, the data representing the driving environment, the first agent token, and the second density token, wherein the diffusion model is configured to generate the synthetic driving scene by iteratively applying a de-noising algorithm to a noise sample;
generating, based at least in part on an output of the diffusion model, the synthetic driving scene including the synthetic agent associated with the agent data and a number of additional synthetic agents based on the second density token, wherein the diffusion model is trained to position the number of additional synthetic agents in the synthetic driving scene based at least in part on the first agent token; and
performing a driving simulation based at least in part on the synthetic driving scene.

2. The system of claim 1, the operations further comprising:
controlling a simulated vehicle during the driving simulation using an autonomous vehicle controller, wherein the synthetic agent and the number of additional synthetic agents are controlled during the driving simulation based at least in part on a separate agent controller; and
transmitting, based at least in part on a result of the driving simulation, the autonomous vehicle controller to an autonomous vehicle configured to use the autonomous vehicle controller to control the autonomous vehicle in a physical driving environment.

3. The system of claim 1, the operations further comprising:
determining a third agent token representing a second synthetic agent to be generated in the synthetic driving scene, the third agent token including a second feature vector representing at least a size of the second synthetic agent and a position of the second synthetic agent in the driving environment,
wherein:
the diffusion model is trained to generate the number of additional synthetic agents within the synthetic driving scene based at least in part on the first agent token and the third agent token.

4. The system of claim 1, wherein:
the feature vector of the first agent token further includes data representing at least one of a first trajectory or a first driving behavior associated with the synthetic agent.

5. The system of claim 4, wherein the diffusion model is trained to determine a position for the number of additional synthetic agents in the synthetic driving scene, based at least in part on the first trajectory or the first driving behavior associated with the first synthetic agent.

6. A method comprising:
receiving, by a scene generator, data representing a driving environment for a synthetic driving scene to be generated;
receiving, by the scene generator, agent data representing an attribute of a synthetic agent to be generated in the synthetic driving scene;
determining, based at least in part on the agent data, a first agent token of an agent token type;
receiving, by the scene generator, desired scene density data for the synthetic driving scene to be generated;
determining, based at least in part on the desired scene density data, a second density token of a scene density token type; and
providing the first agent token and the second density token as input to a scene diffusion model, and executing the scene diffusion model to generate the synthetic driving scene by iteratively applying a de-noising algorithm to a noise sample, wherein execution of the scene diffusion model is based at least in part on the driving environment, the first agent token, and the second density token. synthetic

7. The method of claim 6, wherein the first agent token includes a feature vector representing:
a size of the synthetic agent;
a position of the synthetic agent; and
a heading of the synthetic agent.

8-10. (canceled)

11. The method of claim 6, wherein the agent data includes data representing:
a first position within the driving environment at which the synthetic agent is to be generated; and
a first trajectory associated with the synthetic agent.

12. The method of claim 11, wherein the scene diffusion model is configured to determine, for a number of additional objects, a position in the synthetic driving scene, based at least in part on the first trajectory associated with the synthetic agent.

13. The method of claim 6, further comprising:
generating, using the scene diffusion model, a second synthetic driving scene based at least in part on the driving environment, the first agent token, and the second density token, the second synthetic driving scene different from the synthetic driving scene, wherein:
generating the synthetic driving scene comprises providing, to the scene diffusion model, the noise sample, the data representing the driving environment, the first agent token, and the second density token; and
generating the second synthetic driving scene comprises providing, to the scene diffusion model, a second noise sample different from the noise sample, the data representing the driving environment, the first agent token, and the second density token.

14. The method of claim 13, wherein the synthetic driving scene includes a first set of objects and the second synthetic driving scene includes a second set of objects, and wherein the method further comprises:
performing a first driving simulation, based at least in part on the synthetic driving scene, to simulate potential interactions between a vehicle and the first set of objects in the driving environment; and
performing a second driving simulation, based at least in part on the second synthetic driving scene, to simulate potential interactions between the vehicle and the second set of objects in the driving environment.

15. One or more non-transitory computer-readable media storing instructions executable by a processor, wherein the instructions, when executed, cause the processor to perform operations comprising:
receiving, by a scene generator, data representing a driving environment for a synthetic driving scene to be generated;
receiving, by the scene generator, agent data representing an attribute of a synthetic agent to be generated in the synthetic driving scene;
determining, based at least in part on the agent data, a first agent token of an agent token type;
receiving, by the scene generator, desired scene density data for the synthetic driving scene to be generated;
determining, based at least in part on the desired scene density data, a second density token of a scene density token type; and
providing the first agent token and the second density token as input to a scene diffusion model, and executing the scene diffusion model configured to generate the synthetic driving scene by iteratively applying a de-noising algorithm to a noise sample, wherein execution of the scene diffusion model is based at least in part on the driving environment, the first agent token, and the second density token.

16. The one or more non-transitory computer-readable media of claim 15, wherein the first agent token includes a feature vector representing:
a size of the synthetic agent;
a position of the synthetic agent; and
a heading of the synthetic agent.

17. The one or more non-transitory computer-readable media of claim 15, the operations further comprising:
determining, by the scene generator, a third agent token scene;
associated with a second synthetic agent to be generated in the synthetic driving scene, wherein
the scene diffusion model is trained to generate first synthetic agent, the second synthetic agent, and a number of additional objects within the synthetic driving scene based at least in part on the first agent token, the second density token, and the third agent token.

18. The one or more non-transitory computer-readable media of claim 17, wherein:
the first agent token includes data representing a first set of attributes associated with the first synthetic agent; and
the third agent token includes data representing a second set of attributes associated with the second synthetic agent, wherein the first set of attributes is different from the second set of attributes.

19. (canceled)

20. The one or more non-transitory computer-readable media of claim 15, wherein the agent data includes data representing:
a first position within the driving environment at which the synthetic agent is to be generated; and
a first trajectory associated with the synthetic agent

21. The method of claim 6, wherein the desired scene density data comprises a dropout percentage associated with generating the synthetic driving scene.

22. The method of claim 6, wherein executing the scene diffusion model comprises using the first agent token and the second density token as conditioning inputs during a plurality of diffusion inference operations.

23. The method of claim 6, wherein providing the first agent token and the second density token as input to the scene diffusion model comprises:
encoding the first agent token into a first embedding, using a first token encoder associated with the agent token type; and
encoding the second density token into a second embedding, using a second token encoder associated with the scene density token type.

24. The method of claim 23, wherein providing the first agent token and the second density token as input to the scene diffusion model further comprises:
providing the first embedding and the second embedding to a same cross-attention layer of the scene diffusion model.
